(19) United States
(12) Patent Application Publication
(10) Pub. No.: US 2023/0351920 A1
(43) Pub. Date: Nov. 2, 2023

(54) BIOPSY PHANTOM

(71) Applicant: Vanderbilt University, Nashville, TN (US)

(72) Inventor: Nicholson S. Chadwick, Nashville, TN (US)

(21) Appl. No.: 18/309,362

(22) Filed: Apr. 28, 2023

Related U.S. Application Data
(60) Provisional application No. 63/385,112, filed on Nov. 28, 2022.
(60) Provisional application No. 63/336,867, filed on Apr. 29, 2022.

(51) Int. Cl. G09B 23/30

(52) U.S. Cl. CPC G09B 23/30

(57) ABSTRACT

A phantom for biopsy training includes a first section, a second section, and a third section. The first section includes a minimum thickness of greater than or equal to 15 mm, a maximum thickness of less than or equal to 30 mm, and a hardness of less than or equal to 16 Hv. The second section at least partially surrounds the first section and includes a minimum thickness of greater than or equal to 10 mm, a maximum thickness of less than or equal to 30 mm, and a hardness of less than or equal to 65 Hv. The third section at least partially surrounds the second section and includes a minimum thickness of greater than or equal to 25 mm, a maximum thickness of less than or equal to 45 mm, and a hardness less than that of each of the first section and the second section.

### CROSS-REFERENCE TO RELATED APPLICATIONS

The present application claims priority to U.S. Provisional Patent Application No. 63/336,867, filed Apr. 29, 2022, and to U.S. Provisional Patent Application No. 63/385,112, filed Nov. 28, 2022, the contents of each of which are incorporated by reference herein.

### BACKGROUND

Biopsies in medicine require extensive knowledge of human anatomy, pathology, and mastery of spatial orientation and tactile feedback. The latter require hands-on training that is particularly difficult to teach without real-time patient interaction. While complications of image guided biopsy are rare, they have been documented, and the ability to practice biopsy techniques in a simulated environment is beneficial to both operator and patient. This training is primarily achieved through phantoms or cadaveric specimens. While soft tissue ultrasound guided biopsy phantoms and training molds are readily available, there is a paucity of bone biopsy training models.

### SUMMARY

The present disclosure relates, in some aspects, to a phantom for use in biopsy training. The phantom includes a first section, a second section, and a third section. The first section includes a minimum thickness of greater than or equal to 15 millimeters (mm), a maximum thickness of less than or equal to 30 mm, and a hardness of less than or equal to 16 on the Vickers Microhardness scale (Hv). The second section at least partially surrounds the first section. The second section includes a minimum thickness of greater than or equal to 10 mm, a maximum thickness of less than or equal to 30 mm, and a hardness of less than or equal to 65 Hv. The third section at least partially surrounds the second section. The third section includes a minimum thickness of greater than or equal to 25 mm, a maximum thickness of less than or equal to 45 mm, and a hardness that is less than that of each of the first section and the second section.

The present disclosure also relates, in some aspects, to a phantom for use in biopsy training that includes a first section, a second section, and a third section. The second section includes a cavity defined therein. The cavity of the second section receives the first section therein. The third section also includes a cavity defined therein. The cavity of the third section receives the second section therein. The second section has a hardness that is greater than a hardness of each of the first section and the third section. Each of the second section and the third section includes a planar surface configured to engage a support surface.

The present disclosure also relates, in some aspects, to a phantom for use in biopsy training that includes a first section, a second section, and a third section. The first section extends along a longitudinal axis of the phantom and includes a thickness in a height direction of the phantom that varies along the longitudinal axis. The thickness of the first section ranges from less than 15 mm to greater than 20 mm. The second section extends along the longitudinal axis of the phantom and includes a thickness in the height direction of the phantom that varies along the longitudinal axis. The thickness of the second section ranges from less than 5 mm to greater than 8 mm. The second section has a hardness greater than that of the first section. The third section extends along the longitudinal axis of the phantom and includes a thickness in the height direction of the phantom that varies along the longitudinal axis. The thickness of the third section ranges from less than 10 mm to greater than 65 mm. The third section has a hardness that is less than the hardness of the second section.

Other aspects of the disclosure will become apparent by consideration of the detailed description and accompanying drawings.

### BRIEF DESCRIPTION OF THE DRAWINGS

FIGS. 1(a)-1(d) illustrate a phantom for use in biopsy training according to embodiments disclosed herein.

FIG. 2 illustrates mold components of the phantom of FIGS. 1(a)-1(d).

FIG. 3 illustrates the mold components of FIG. 2.

FIG. 4 illustrates materials for the phantom of FIGS. 1(a)-1(d).

FIG. 5 illustrates bench testing a sample of the material used for the second section with a bone biopsy needle.

FIG. 6 illustrates a satisfactory biopsy sample from coring the sample of the material for the second section.

FIG. 7 illustrates the first and second sections of the phantom of FIGS. 1(a)-1(d).

FIG. 8 illustrates a perspective view of a phantom according to embodiments disclosed herein.

FIG. 9 illustrates the first and second sections of the phantom of FIG. 8.

FIG. 10 illustrates an upper mold component for manufacturing the third section of the phantom of FIG. 8.

FIG. 11 illustrates a lower mold component for manufacturing the third section of the phantom of FIG. 8.

FIG. 12 illustrates a perspective view of a phantom according to embodiments disclosed herein.

FIG. 13 illustrates a perspective view of the first section and the second section of the phantom of FIG. 12.

FIG. 14 illustrates a perspective view of the first section of the phantom of FIG. 12.

FIG. 15 illustrates a perspective view of a phantom according to embodiments disclosed herein.

FIGS. 16(a) and 16(b) illustrate front and rear elevation views of the phantom of FIG. 15.

FIG. 17 illustrates a bottom plan view of the phantom of FIG. 15.

FIG. 18 illustrates a side elevation cross-sectional view of the phantom of FIG. 15.

FIG. 19 illustrates a side elevation cross-sectional view of a phantom according to embodiments disclosed herein.

FIG. 20 illustrates a side elevation cross-sectional view of a phantom according to embodiments disclosed herein.

FIGS. 21(a)-21(c) illustrate front elevation cross-sectional views of the phantom of FIG. 20.

FIG. 22 illustrates a scan image of a human posterior iliac bone, which is simulated by the area of the phantom shown in FIG. 21(a).

FIG. 23 illustrates a scan image of a human subtrochanteric femur diaphysis, which is simulated by the area of the phantom shown in FIG. 21(b).

FIG. 24 illustrates a scan image of a human anterior tibia proximal third diaphysis, which is simulated by the area of the phantom shown in FIG. 21(c).

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

A bone biopsy training phantom (or model) that meets the material properties of subcutaneous fat, fascia, muscle, trabecular and cortical bone would be beneficial. In addition, in some embodiments of the present disclosure, the phantom adequately simulates an osteoblastic bone lesion. In some embodiments, the design is cost-effective, resource conscious, and easily reproduceable in order to disseminate to as many training environments as possible. In addition, some embodiments of the phantom may be used by industry to serve as a platform on which to introduce bone biopsy systems to potential clients of hospitals and individual physician groups.

Embodiments of the phantom discussed below, from a materials properties standpoint, mimics the tissues encountered during biopsy: fat, fascia, muscle, trabecular and cortical bone. Further, embodiments of the phantom discussed below take into account a tapered cortical bone surface, which provide medical professionals with an opportunity to practice handling the unique technical challenges in performing bone biopsies. These technical challenges include, for example, needle slippage on a sloped or curved surface and biopsy of a densely sclerotic region of bone, which is a known potential area for needle deformation/sticking. Some embodiments of the phantom may also be applied to the field of orthopedics training (e.g., practice of surgical hardware fixation and other surgical techniques).

Heterogeneity refers to the spatial variation in structure and properties of materials. The primary challenge of creating a bone biopsy system is to engineer a homogenous phantom (or model) designed to mimic something inherently heterogeneous. Porosity, collagen fiber orientation, density, and mineralization all contribute to the structural integrity of bone. These factors and their varied effect on the mechanical properties of bone has been measured from the macro- (whole bone) to nano-scale.

Hardness—a measure of a material's resistance to plastic and elastic deformation by indentation—is one of the most important material properties of bone and of central importance to materials engineering. The degree and distribution of mineralization and composition of trabecular and cortical bone have direct effects on the hardness and mechanical properties of bone. The bone in the human body with the highest hardness is tibial cortical bone, which has a hardness of up to 51.2 Hv.

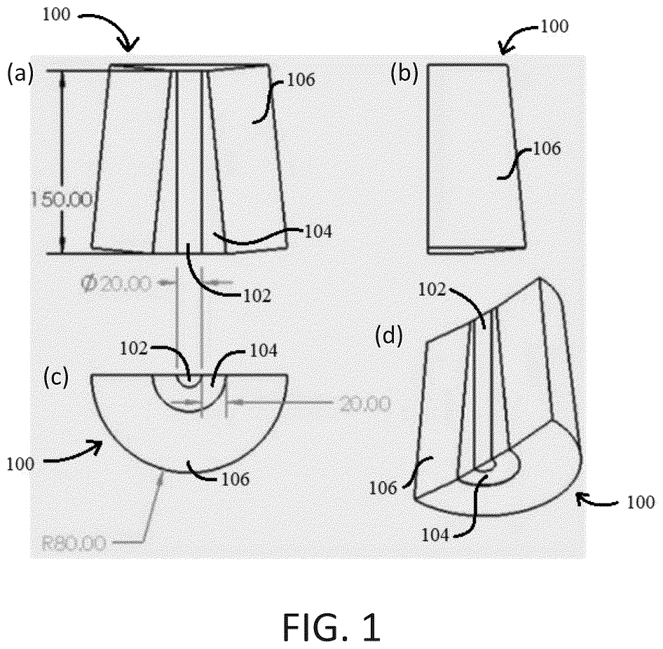

FIGS. 1(a)-1(d) illustrate a bone biopsy training phantom (or model) 100 according to an embodiment of the present disclosure. The phantom 100 simulates the material properties of subcutaneous fat, fascia, muscle, trabecular bone, and cortical bone. As illustrated, the phantom 100 is separated into three parts. The phantom 100 is not limited to only three parts, but can include more or fewer parts and sections. The innermost section (or first section) 102 serves to simulate medullary bone. The middle section (or second section) 104 serves to simulate cortical bone. The outermost section (or third section) 106 serves to simulate the soft tissues—muscle, fascia, and subcutaneous fat.

The first section 102 includes a material that mimics medullary bone. For example, the first section 102 can have a hardness, a porosity, or both that mimics medullary bone. In some embodiments, the inner layer has a Vickers Microhardness of greater than or equal to 10 Hv, greater than or equal to 15 Hv, greater than or equal to 20 Hv, or greater than or equal to 30 Hv. In some embodiments, the first section 102 has a hardness of less than or equal to 60 Hv, less than or equal to 50 Hv, less than or equal to 40 Hv, or less than or equal to 30 Hv. In some embodiments, the first section 102 has a hardness of about 10 Hv to about 60 Hv, such as about 10 Hv to about 30 Hv or about 12 Hv to about 20 Hv. In some embodiments, the first section 102 has a hardness of about 16 Hv. Hardness can be measured by other techniques known within the art, such as with a portable Shore D Durometer. As such, hardness can also be described as a Shore D hardness.

Materials that can be used for the first section 102 are not generally limited and can include any suitable material that can physically mimic medullary bone (e.g., having a similar hardness) and that can be molded into a desired shape. The material can include an individual material or can include a plurality of different materials. The material can include a polymer resin, a blend thereof, and/or a composite thereof. Example polymer resins include, but are not limited to, epoxy, polyurethane, polypropylene, polyethylene, polyester, polyvinyl chloride, cellulose acetate, cellulose acetate butyrate, and polylactic acid. The hardness of the polymer can be modulated by its processing, crosslinking, and/or additives. Example additives include, but are not limited to, impact modifiers, glass fibers, plasticizers, and mineral fillers (e.g., silica, talc, clay, and glass beads). In some embodiments, the first section 102 includes a polyurethane. In some embodiments, the first section 102 is a polyurethane, such as a polyurethane foam. Polyurethane foam includes a porosity similar to that observed in medullary bone.

As shown in FIGS. 1(a) and 1(c), the first section 102 may include a constant thickness (or diameter in the illustrated embodiment) of 20 mm.

Because medullary bone has a higher porosity than cortical bone, the first section 102 can have a higher porosity relative to the second section 104. In addition, because medullary bone has a lower hardness than cortical bone, the first section 102 can have a lower hardness relative to the second section 104. In some embodiments, the first section 102 has a hardness of about 10% to about 80% less than the hardness of the second section 104, such as about 15% to about 75%, about 30% to about 80%, about 50% to about 75%, or about 10% to about 20% less than the hardness of the second section 104.

The second section 104 can include a material that mimics cortical bone. For example, the second section 104 can have a hardness that mimics cortical bone. In some embodiments, the second section 104 has a Vickers Microhardness of greater than or equal to 50 Hv, greater than or equal to 55 Hv, greater than or equal to 60 Hv, or greater than or equal to 65 Hv. In some embodiments, the second section 104 has a hardness of less than or equal to 70 Hv, less than or equal to 65 Hv, less than or equal to 60 Hv, or less than or equal to 55 Hv. In some embodiments, the second section 104 has a hardness of about 50 Hv to about 70 Hv, such as about 55 Hv to about 65 Hv or about 60 Hv to about 65 Hv. In some embodiments, the second section 104 has a hardness of about 65 Hv. Hardness can be measured by other techniques known within the art, such as with a portable Shore D Durometer. As such, hardness can also be described as a Shore D hardness.

Materials that can be used in the second section 104 are not generally limited and can include any suitable material that can physically mimic cortical bone (e.g., having a similar hardness) and that can be molded into a desired shape. The material can include an individual material or can include a plurality of different materials. The material can include a polymer resin, a blend thereof, and/or a composite thereof. Example polymer resins include, but are not limited to, epoxy, polycarbonate, polyethylene terephthalate, polymethyl methacrylate, polystyrene, polyurethane, polypropylene, polyethylene (e.g., high density polyethylene), polyester, polyvinyl chloride, cellulose acetate, and polylactic acid. The hardness of the polymer can be modulated by its processing, crosslinking, and/or additives. Example additives include, but are not limited to, impact modifiers, glass fibers, plasticizers, and mineral fillers (e.g., silica, talc, clay, and glass beads). In some embodiments, the second section 104 includes an epoxy. In some embodiments, the second section 104 is an epoxy.

As shown in FIGS. 1(a) and 1(c), the second section 104 simulating the cortical bone layer is tapered to allow biopsy practice on a variety of cortical thicknesses (up to 20 mm in some embodiments) while maintaining the same diameter of the first section 102 simulating the medullary bone. In this embodiment, 20 mm was chosen as the upper value for the thickness of the second section 104 to account for the location of thickest cortical bone, the anterior tibia, which has been reported to reach up to 28 mm. This thickness was also chosen to adequately simulate biopsy of a sclerotic bone lesion, a lesion sub-type known to be more technically challenging and to have more variable rates of diagnostic yield. A tapered second section 104 simulating the cortical bone affords the trainee an opportunity to practice a bone biopsy on a sloped surface, which requires an added skillset to prevent needle slippage.

The third section 106 can include a material that mimics soft tissue, such as muscle, facia, subcutaneous fat, and combinations thereof. The third section 106 can have properties that sufficiently hold together the three sections 102, 104, 106, e.g., during biopsy, yet can allow for needle passage. Because soft tissue is softer than medullary bone and cortical bone, the third section 106 can be softer relative to the first section 102 and the second section 104.

Materials that can be used in the third section 106 are not generally limited and can include any suitable material that can physically mimic soft tissue and that can be molded into a desired shape. The material can include an individual material or can include a plurality of different materials. Example materials that can be used in the outer layer include, but are not limited to, psyllium fibers or blends thereof, gelatin (e.g., ballistic gels), hydrogels, and elastomers (e.g., silicone rubber, rubber, and the like). It is beneficial if the third section 106 has material properties to hold together the three sections 102, 104, 106 during the biopsy while still allowing the biopsy needle to pass therethrough.

As shown in FIG. 1(a), the third section 106 may be tapered to simulate the narrowing of a patient's limb. As shown in FIG. 1(c), the third section 106 may also have a radius of curvature of, for example, 80 mm. The entire phantom 100 may have a length of, for instance, 150 mm. All three sections 102, 104, 106 include a planar surface for engaging a support surface. The planar surfaces allow for stable placement of the phantom 100 during the biopsy procedure.

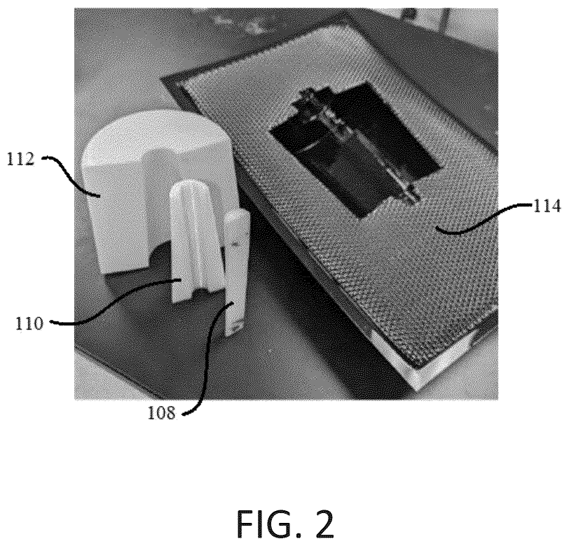

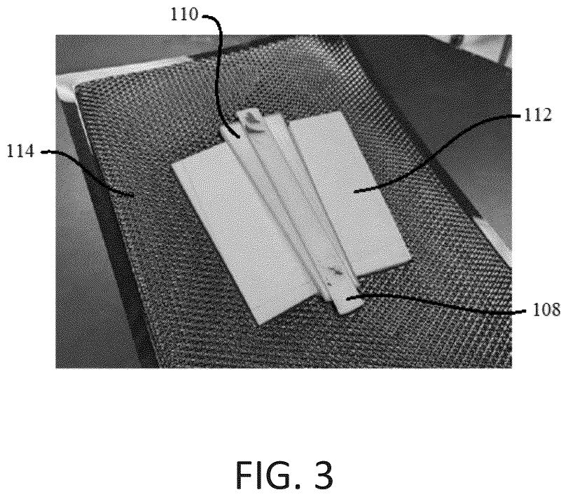

With reference to FIGS. 2 and 3, models 108, 110, 112 of each of the three sections 102, 104, 106 were printed from polylactic acid (PLA) using a 3D printer. These three models 108, 110, 112 were placed in thermoplastic molds, such as the thermoplastic mold 114 shown in FIGS. 2 and 3, which will serve as the templates into which the specific materials are poured to create the phantom 100. In some embodiments, the three models 108, 110, 112 are shaped to provide offsets between the models for ease of assembly of the phantom 100.

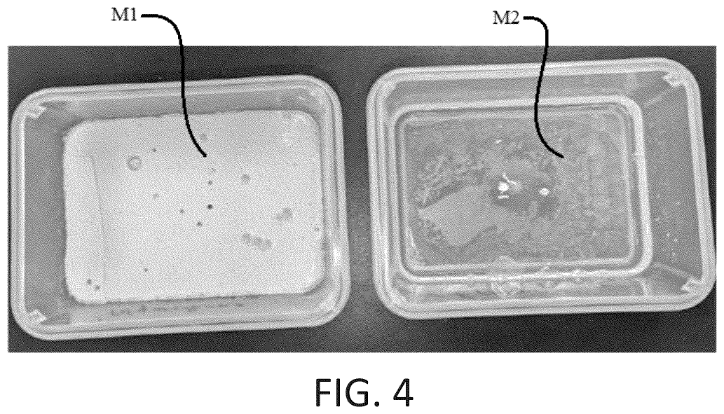

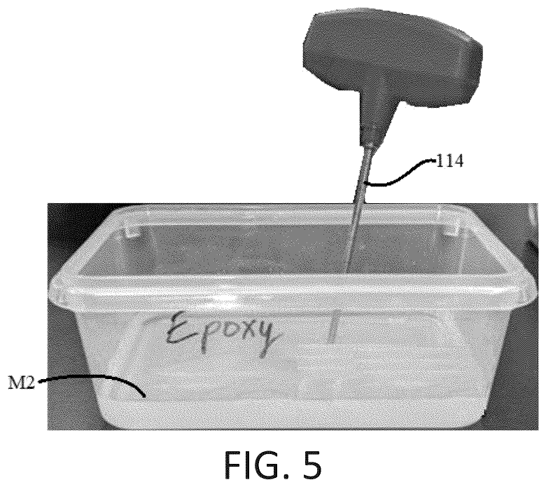

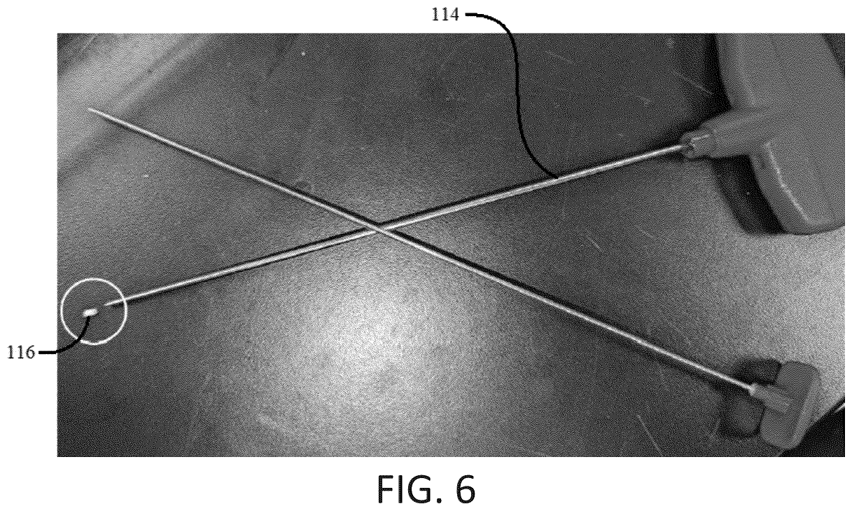

As shown in FIGS. 4 and 5, samples of the materials M1, M2 for the first section 102 and the second section 104, respectively, of the phantom 100 were placed in containers for bench testing with a bone biopsy needle 114. A musculoskeletal radiologist determined these materials demonstrated satisfactory performance in material hardness, tactile feedback, maneuverability (or lack thereof) and the ability to obtain a cortical and medullary core sample. FIG. 6 illustrates the biopsy needle 114 with a sample 116 of the material for use as the second section 104.

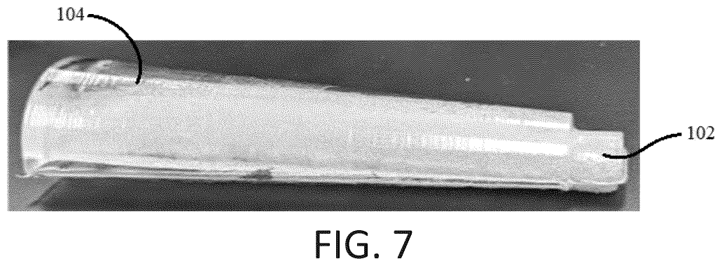

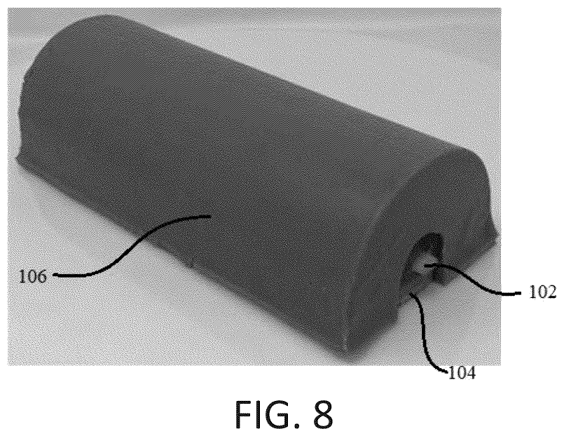

FIG. 7 illustrates the first section 102 at least partially surrounded by the second section 104 without the third section 106. The second section 104 tapers as shown in prior figures. FIG. 8 illustrates the entire assembled phantom 100 including the first section 102, second section 104, and third section 106.

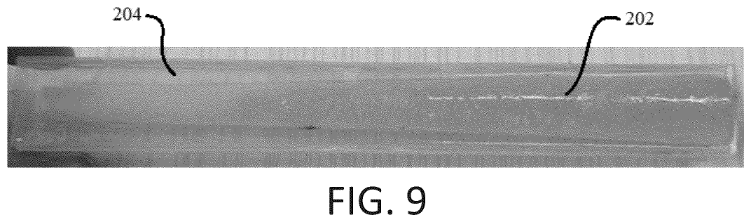

FIG. 9 illustrates another embodiment of the first section 202 and second section 204 without the third section 206. The first section 202 differs from the prior first section 102 in that the first section 202 tapers along its length. The second section 204, then, maintains a relatively constant outer diameter by including a varying thickness along its length to compensate for the taper of the first section 202. The layers were tapered in an inverse fashion so that the ratio of cortical to medullary bone was higher on one end and lower on the other. A higher cortical bone to medullary bone layer provides the trainee an opportunity to perform a biopsy of a dense, sclerotic bone lesion and maximizes opportunities for device failure and subsequent troubleshooting. A low cortical bone to medullary bone ratio provides the trainee an opportunity to experience the loss of resistance that is achieved when the biopsy needle transitions from cortical to medullary bone. Understanding this tactile feedback is essential to safely performing intervention on bones with thinner cortices such as the iliac bone during bone marrow biopsy/aspirate, which is often done without image guidance.

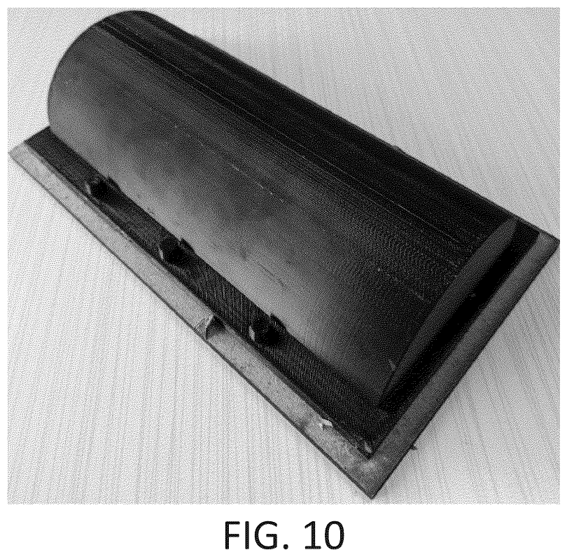

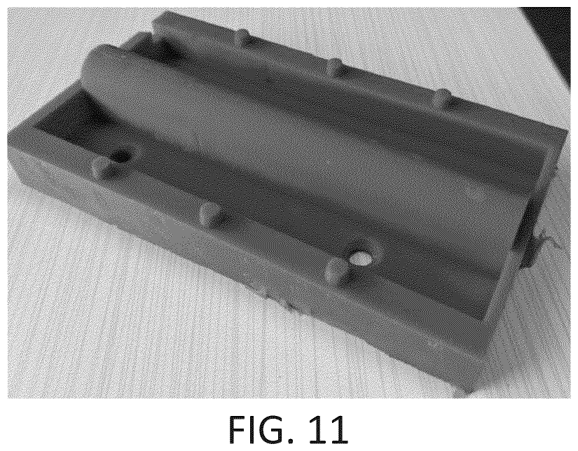

FIGS. 10 and 11 illustrate 3D printed negatives of the third section 206. Similar negatives could be made for each of the first section 202 and second section 204.

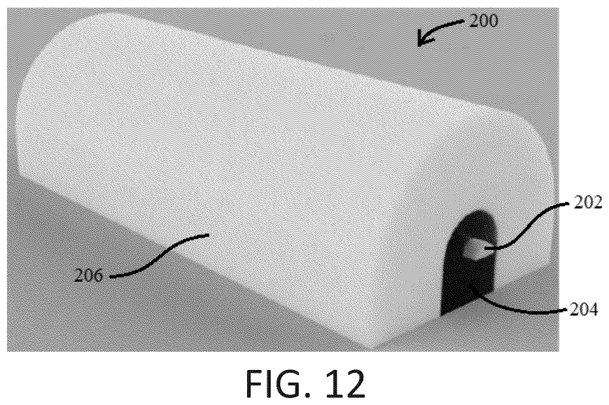

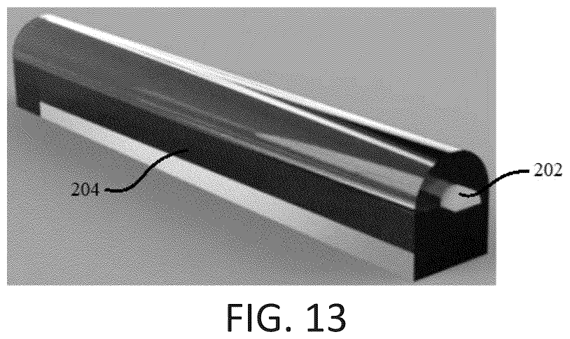

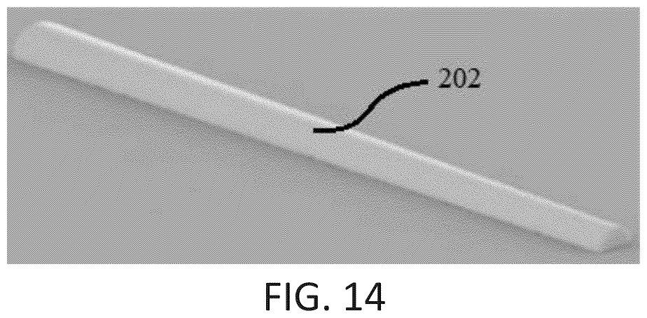

FIGS. 12-14 further illustrate a phantom 200 including the above-described first section 202, second section 204, and third section 206. Both the second section 204 and third section 206 include a planar surface for engaging a support surface. The planar surfaces allow for stable placement of the phantom 200 during the biopsy procedure. While the sections 202, 204, 206 are shown with particular colors, various colorants can be added to the materials to alter the cosmetic appearance of each section.

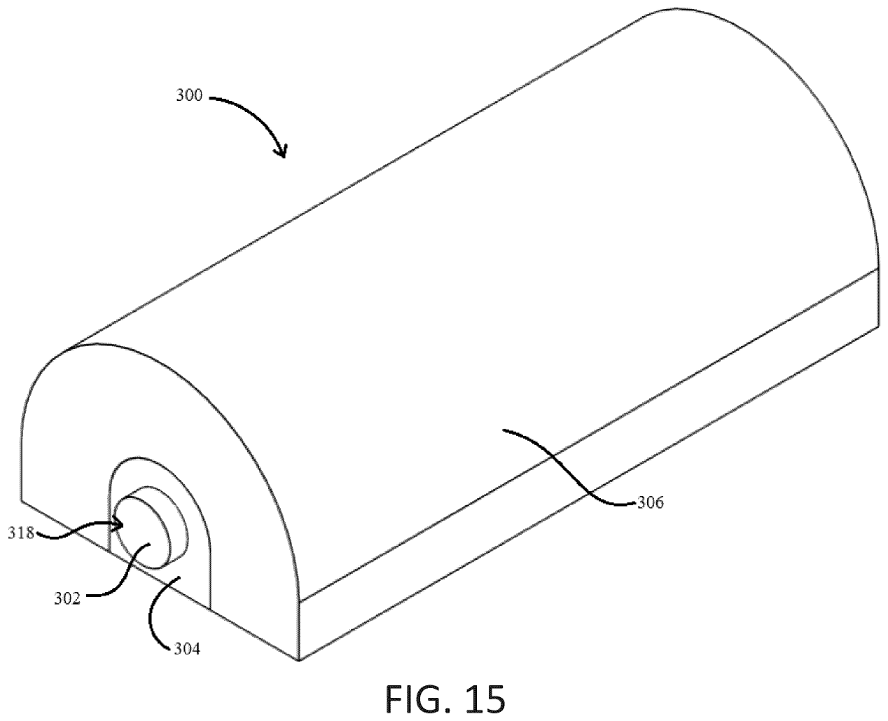

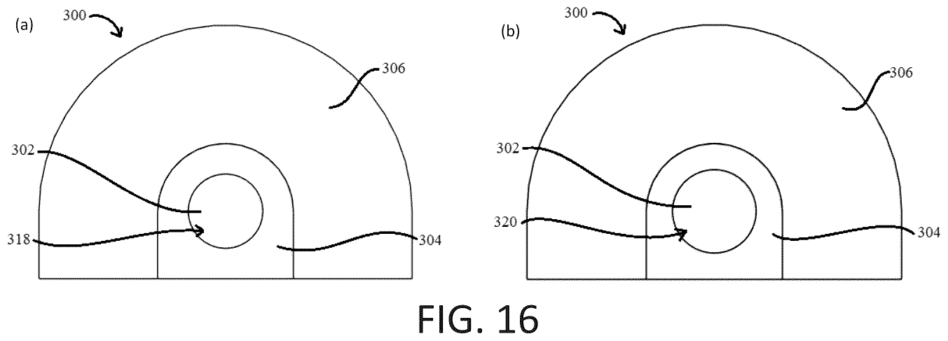

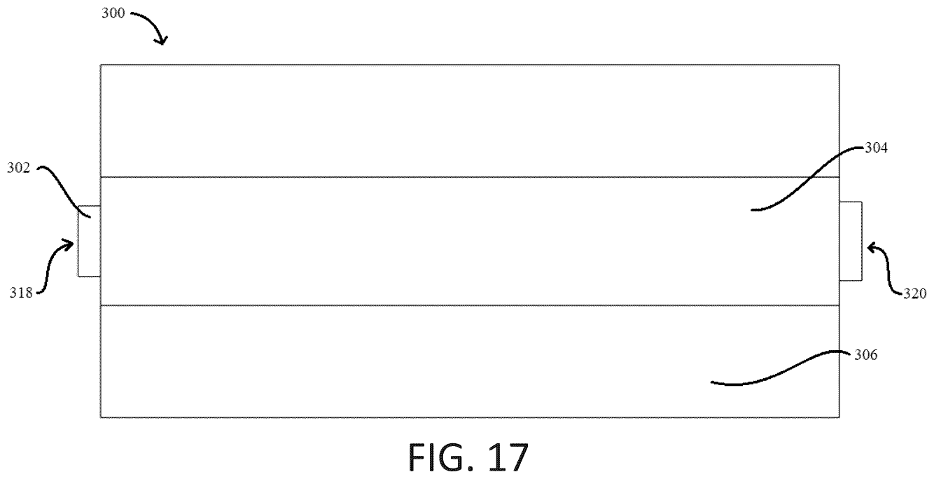

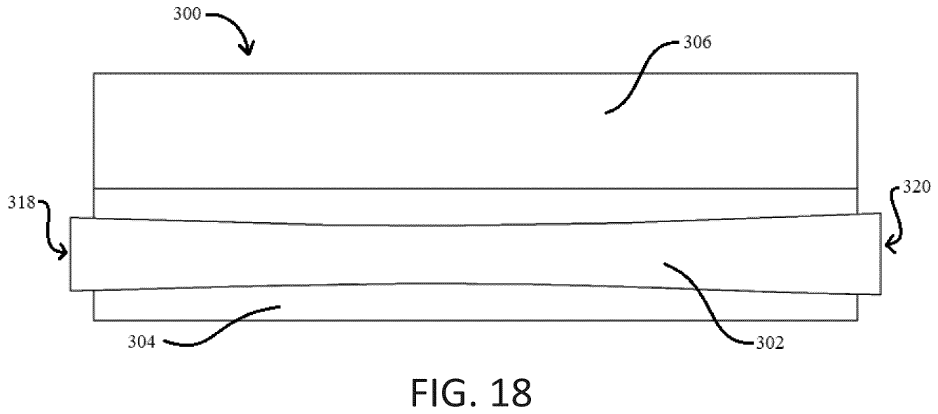

FIGS. 15-18 illustrate yet another phantom 300 according to another embodiment. In the illustrated embodiment, the first section 302 includes a first end 318 and a second end 320 opposite the first end 318. The second end 320 in the illustrated embodiment has a greater thickness than the first end 318, although some embodiments may include the ends 318, 320 having similar or identical thicknesses. Further, the illustrated embodiment includes the first section 302 tapering to a minimum thickness at a location between the ends 318, 320. The second section 304 also varies in thickness to compensate for the changes in thickness of the first section 302, such that the second section 304 includes a constant outer dimension. The third section 306 includes a substantially constant thickness. Both the second and third sections 304, 306 include a planar surface for engaging a support surface. The planar surfaces allow for stable placement of the phantom 300 during the biopsy procedure.

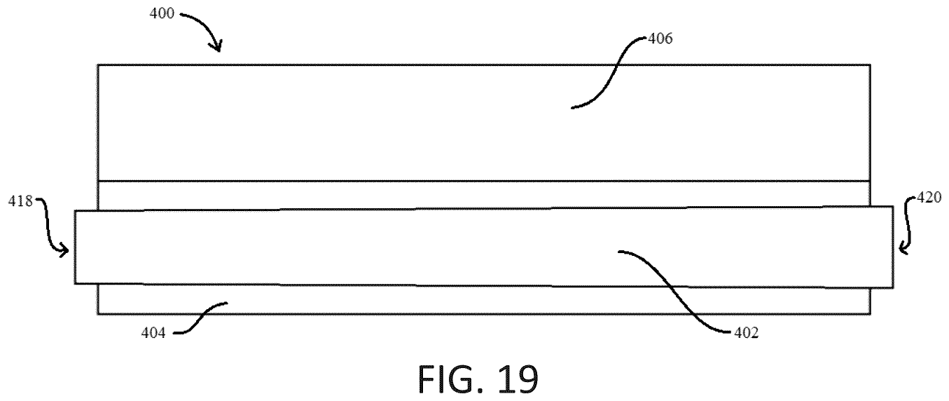

FIG. 19 illustrates another embodiment of the phantom 400. The phantom 400 is similar to the phantom 300 discussed above in that the third section 406 has a constant thickness along the longitudinal axis A of the phantom 300 due to the fact that the second section 404 compensates for the variation in thickness of the first section 402. The first section 402, however, tapers at a constant angle from the second, thicker end 420 to the first, thinner end 418.

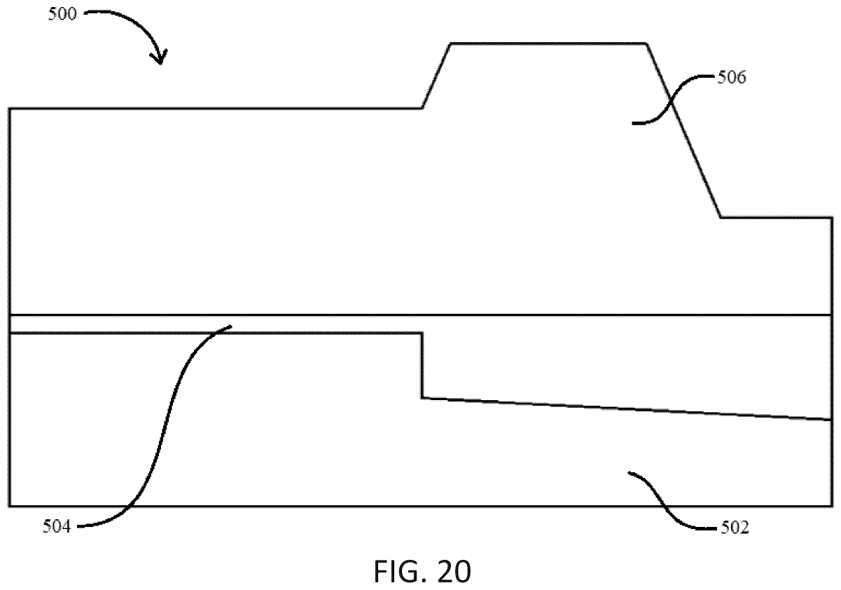

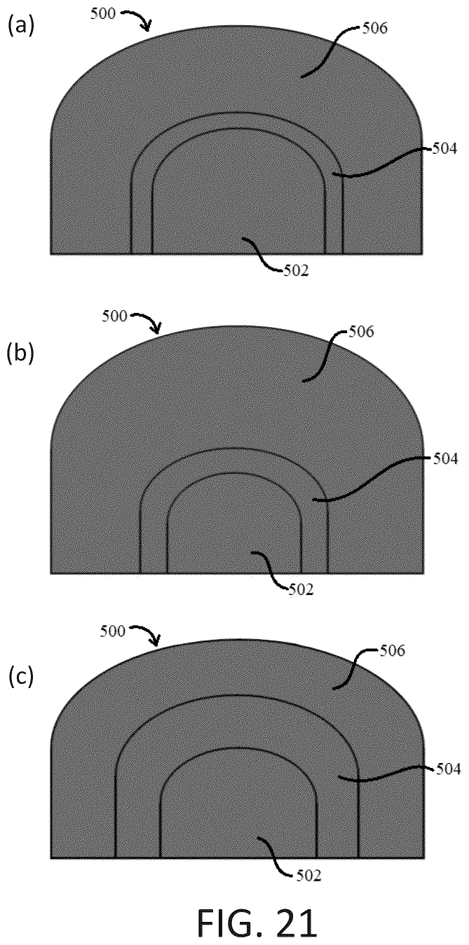

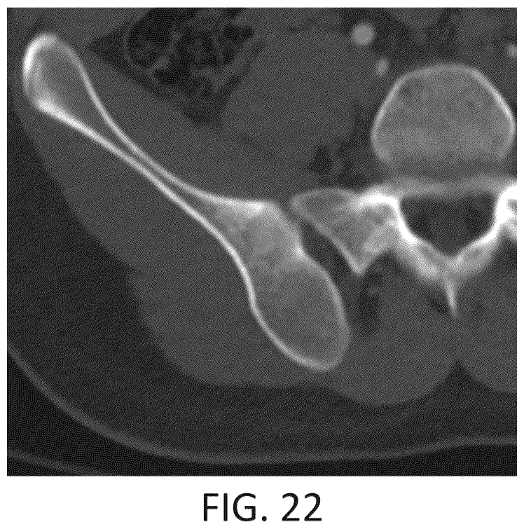

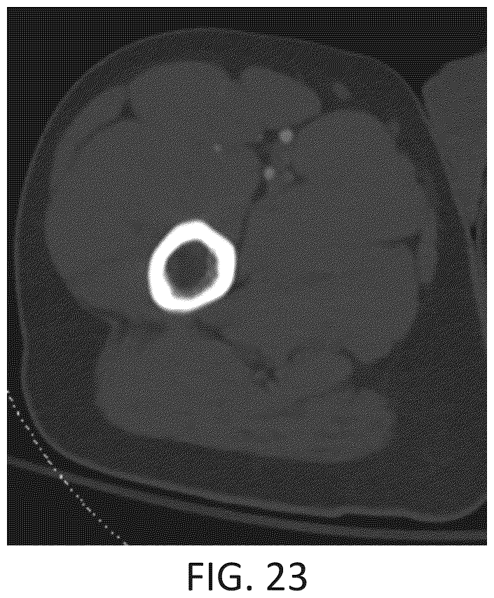

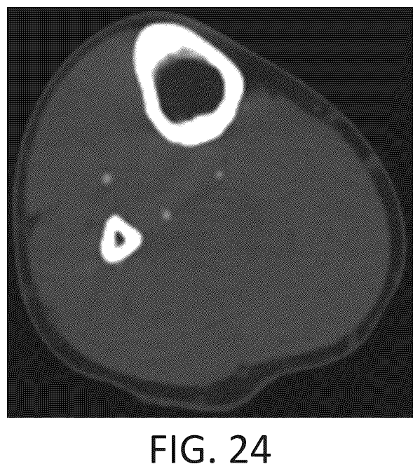

FIGS. 20 and 21(a)-21(c) illustrate still another embodiment of the phantom 500, which is shaped to mimic various locations of a patient's leg, as shown in the scan images of FIGS. 22-24. As shown in FIG. 20, the first section 502 has a constant thickness (of 25 mm in some embodiments) for a portion of its length along the longitudinal axis, then sharply decreases in thickness (to 16 mm in some embodiments), then tapers at a constant angle to an end of the phantom 500 (to 14 mm in some embodiments). The second section 504 has a constant outer dimension to compensate for the changes in thickness of the first section 502, which leads to a minimum thickness (of 2 mm in some embodiments) of the second section 504 that sharply increases (to 7 mm in some embodiments) and then widens at a constant angle to an end of the phantom 500 (to 9 mm in some embodiments). Unlike the other embodiments discussed above, the third section 506 has neither a constant thickness nor a constant outer dimension. Instead, the third section 506 has a constant thickness (of 42 mm in some embodiments) for a portion of the length of the phantom 500 and then widens at an angle until reaching a plateau of another section of constant thickness (of 68 mm in some embodiments) until tapering to a minimum thickness (of 7 mm in some embodiments), which remains constant to the end of the phantom 500. Each of the variations in thicknesses represents a different portion of a patient's limb, such as a leg. The left-most portion of the phantom 500 in FIG. 20 most closely simulates the posterior iliac bone and surrounding tissue of a patient (scan of which is shown in FIG. 22). The middle portion of the phantom 500 in FIG. 20 most closely simulates the femur and surrounding tissue of a patient (scan of which is shown in FIG. 23). The right-most portion of the phantom 500 in FIG. 20 most closely simulates the tibia and surrounding tissue of a patient (specifically, the proximal third of the diaphysis of the tibia) (scan of which is shown in FIG. 24).

Any of the embodiments discussed herein may include the first section 102, 202, 302, 402, 502 having a minimum thickness of greater than or equal to 15 mm and a maximum thickness of less than or equal to 30 mm. In some embodiments, the minimum thickness is greater than or equal to 17 mm. In some embodiments, the minimum thickness is less than or equal to 15 mm. In some embodiments, the maximum thickness is greater than or equal to 20 mm. In some embodiments, the minimum thickness is 14 mm. In some embodiments, the maximum thickness is 25 mm. In some embodiments, the maximum thickness is 16 mm.

Any of the embodiments discussed herein may include the second section 104, 204, 304, 404, 504 having a minimum thickness of greater than or equal to 10 mm and a maximum thickness of less than or equal to 30 mm. In some embodiments, the minimum thickness is greater than or equal to 11 mm. In some embodiments, the minimum thickness is less than or equal to 5 mm. In some embodiments, the maximum thickness is greater than or equal to 8 mm. In some embodiments, the minimum thickness is 2 mm. In some embodiments, the maximum thickness is 9 mm.

Any of the embodiments discussed herein may include the third section 106, 206, 306, 406, 506 having a minimum thickness of less than or equal to 10 mm and a maximum thickness of greater than or equal to 65 mm. In some embodiments, the minimum thickness is greater than or equal to 25 mm. In some embodiments, the maximum thickness is less than or equal to 45 mm. In some embodiments, the thickness is 35 mm. In some embodiments, the minimum thickness is 7 mm. In some embodiments, the maximum thickness is 68 mm. In some embodiments, the minimum thickness is 20 mm. In some embodiments, the maximum thickness is 66 mm.

Any of the embodiments discussed herein may include the phantom 100, 200, 300, 400, 500 having a maximum height of less than or equal to 100 mm and a minimum height of greater than or equal to 20 mm. In some embodiments, at least 70% of the maximum height of the phantom 100, 200, 300, 400, 500 is made up of the third section 106, 206, 306, 406, 506. In some embodiments, no greater than 30% of the minimum height of the phantom 100, 200, 300, 400, 500 is made up of the third section 106, 206, 306, 406, 506.

These angles and thicknesses are exemplary, and other embodiments with different angles and thicknesses are contemplated herein even if not explicitly discussed.

We claim:

1. A phantom for use in biopsy training, the phantom comprising:
a first section including a minimum thickness of greater than or equal to 15 mm, a maximum thickness of less than or equal to 30 mm, and a hardness of less than or equal to 16 Hv;
a second section at least partially surrounding the first section, the second section including a minimum thickness of greater than or equal to 10 mm, a maximum thickness of less than or equal to 30 mm, and a hardness of less than or equal to 65 Hv; and
a third section at least partially surrounding the second section, the third section including a minimum thickness of greater than or equal to 25 mm, a maximum thickness of less than or equal to 45 mm, and a hardness less than that of each of the first section and the second section.

2. The phantom of claim 1, wherein the first section includes a polyurethane foam.

3. The phantom of claim 1, wherein the second section includes epoxy.

4. The phantom of claim 1, wherein the third section includes a psyllium fiber blend.

5. The phantom of claim 1, wherein the third section includes ballistic gel.

6. The phantom of claim 1, wherein
the first section extends along a longitudinal axis of the phantom such that both ends of the first section are intersected by the longitudinal axis, and
a location of the minimum thickness of the first section is located between the ends of the first section.

7. The phantom of claim 6, wherein the first section tapers continuously from each of the ends of the first section to the location of the minimum thickness.

8. The phantom of claim 6, wherein the minimum thickness of the first section is greater than 17 mm.

9. The phantom of claim 1, wherein each of the minimum thickness and the maximum thickness of the first section is a diameter of the first section measured in a plane orthogonal to a longitudinal axis of the first section.

10. The phantom of claim 1, wherein the minimum thickness of the second section is greater than 11 mm.

11. The phantom of claim 1, wherein the third section has a thickness of 35 mm.

12. The phantom of claim 1, wherein
the first section is circular in cross-section in a plane orthogonal to a longitudinal axis of the phantom,
the thickness of the second section is measured in a radial direction relative to the longitudinal axis, and
the thickness of the third section is measured in a radial direction relative to the longitudinal axis.

13. The phantom of claim 1, wherein each of the second section and the third section includes a planar surface for engaging a support surface.

14. The phantom of claim 1, wherein
the first section further includes
the minimum thickness disposed at one end, and
the maximum thickness disposed at an opposite end, and
the first section tapers continuously from the end having the maximum thickness to the end having the minimum thickness.

15. The phantom of claim 1, wherein
the second section further includes
the minimum thickness disposed at one end, and
the maximum thickness disposed at an opposite end, and
the second section tapers continuously from the end having the maximum thickness to the end having the minimum thickness.

16. A phantom for use in biopsy training, the phantom comprising:
a first section;
a second section including a cavity defined therein, the cavity of the second section receiving the first section therein; and
a third section including a cavity defined therein, the cavity of the third section receiving the second section therein,
wherein
the second section has a hardness that is greater than a hardness of each of the first section and the third section, and
each of the second section and the third section includes a planar surface configured to engage a support surface.

17. The phantom of claim 16, wherein the first section includes a planar surface configured to engage the support surface, the planar surface of the first section being flush with the planar surface of the second section and the planar surface of the third section.

18. The phantom of claim 17, wherein
the phantom extends along a longitudinal axis,
the phantom includes a height extending in a direction orthogonal to the longitudinal axis, and
the height of the phantom varies along the longitudinal axis.

19. The phantom of claim 18, wherein
the phantom includes a maximum height of less than or equal to 100 mm,
the phantom includes a minimum height of greater than or equal to 20 mm,
at least 70% of the maximum height of the phantom is made up of the third section, and
no greater than 30% of the minimum height of the phantom is made up of the third section.

20. A phantom for use in biopsy training, the phantom comprising:
a first section extending along a longitudinal axis of the phantom, the first section including a thickness in a height direction of the phantom that varies along the longitudinal axis, the thickness of the first section ranging from less than 15 mm to greater than 20 mm;
a second section extending along the longitudinal axis of the phantom, the second section including a thickness in the height direction of the phantom that varies along the longitudinal axis, the thickness of the second section ranging from less than 5 mm to greater than 8 mm, the second section having a hardness greater than that of the first section; and
a third section extending along the longitudinal axis of the phantom, the second section including a thickness in the height direction of the phantom that varies along the longitudinal axis, the thickness of the third section ranging from less than 10 mm to greater than 65 mm, the third section having a hardness that is less than the hardness of the second section.
